(19) United States
(12) Patent Application Publication
(10) Pub. No.: US 2026/0335814 A1
(43) Pub. Date: Oct. 29, 2026

(54) DEHUMIDIFIER AND CONTAINER FOR DEHUMIDIFIER

(71) Applicant: OKAMOTO INDUSTRIES, INC., Tokyo (JP)

(72) Inventor: Hitoshi UCHIYAMA, Tokyo (JP)

(73) Assignee: OKAMOTO INDUSTRIES, INC., Tokyo (JP)

(21) Appl. No.: 19/114,589

(22) PCT Filed: Feb. 14, 2024
(86) PCT No.: PCT/JP2024/004920

§ 371 Date: Mar. 24, 2025

(30) Foreign Application Priority Data
Apr. 26, 2023 (JP) 2023-072065

(51) Int. Cl. B01D 53/26; B01D 53/04; B01D 53/28

(52) U.S. Cl. CPC B01D 53/261; B01D 53/0415; B01D 53/28; B01D 2253/112; B01D 2257/80

(57) ABSTRACT

A dehumidifier uses a tablet and a dedicated container, in which the tablet is a hygroscopic desiccant in a state in which a deliquescent substance is pressurized and compressed. The container includes a deliquescent solution storage container, a lid, and a shelf for placing a tablet. The deliquescent solution storage container has an engaging portion for disposing the shelf at a predetermined height position from an inner bottom surface, and is capable of storing a deliquescent solution of the tablet. The lid ensures firm connection to the deliquescent solution storage container in a state in which the shelf is interposed. The lid has an opening portion on an upper surface, and the opening portion is sealed with a moisture permeable film. The shelf has a hole at least downwardly for allowing the deliquescent solution of the tablet to flow down to the deliquescent solution storage container.

### TECHNICAL FIELD

The present invention relates to a dehumidifier and a container thereof, which absorb moisture in air with a hygroscopic desiccant to lower humidity of a space and keep the humidity low, and are used in a closet, a chest of drawers, a shoe box, and other storage spaces.

### BACKGROUND ART

In the related art, a so-called tank type dehumidifier, which is formed by partitioning an upper space and a lower space by interposing a saucer in a middle-high portion of a container having an upper surface opening portion, accommodating a granular hygroscopic desiccant in the upper space, and storing a deliquescent solution of the hygroscopic desiccant in the lower space to be dropped from a dropping hole of the saucer, has become mainstream. The tank type dehumidifier is configured such that a moisture permeable film through which liquid does not pass but gas passes is adhered or welded to the upper surface opening portion to seal the opening so that the deliquescent solution does not spill when the tank type dehumidifier is accidentally overturned. Furthermore, in order to improve the moisture absorption performance of the dehumidifier, it is important to ensure a large contact area between the hygroscopic desiccant and the air. A common configuration is to have a saucer with multiple protrusion portions arranged in stages, and to store granular hygroscopic desiccant in the upper space thus formed (JP2011-78865A).

### CITATION LIST

### Patent Literature

[PTL 1] JP2011-78865A

### SUMMARY OF INVENTION

### Technical Problem

As shown in FIG. 9, the tank type dehumidifier described in JP2011-78865A is configured to include: container main body 4 having an upper surface opening portion; a grating-shaped saucer 5 that is located in a middle-high portion of the container main body 4 and that divides the inside of the container main body 4 into an upper space N and a lower space M; and a moisture permeable film 6 that is moisture permeable and non-water permeable and that closes the upper surface opening portion, and a sealing sheet 7. The tank type dehumidifier includes a lid body 8 that protects the moisture permeable film 6 and the sealing sheet 7 and is attachable to and detachable from the upper surface opening portion of the container main body 4. In the tank type dehumidifier configured as described above, the hygroscopic desiccant C in a granular form is accommodated in the upper space N in the container main body 4, and when a consumer (user) uses the tank type dehumidifier, the sealing sheet 7 is peeled off from the top of the moisture permeable film 6, so that moisture in the air passes through the moisture permeable film 6 and flows into the container main body 4, and is absorbed by the hygroscopic desiccant. When the deliquescence of the hygroscopic desiccant progresses and is completely lost, the deliquescent solution that has accumulated is allowed to flow by peeling off the moisture permeable film 6 adhered to the upper surface opening portion, and the container is discarded.

Therefore, since the used tank type dehumidifier needs to be replaced with a new one as a whole, the cost is high and the waste of resources is also caused. In addition, this is not simply a problem of cost or resource waste, but also leads to a problem of having to purchase and transport a large and bulky product, or a problem of requiring space for a storage location of a stock item, which is a labor for consumers. As described above, the container is naturally large from the required specification of securing the contact area between the hygroscopic desiccant and the air. Transport or store air in a space in which a multi-stage protrusion portion is disposed, in addition to the volumes of the upper space and the lower space. Furthermore, this is a more serious problem not only for consumers but also for manufacturers, wholesalers, and retailers. Because it forces companies to have large transport capacity or secure space for transport or storage of products in warehouses or the like, which results in a significant increase in transport and storage costs.

On the other hand, it has been a long time since the voice of the efforts of companies for sustainability has been heard, and regarding the development of sustainable materials and how to build a mechanism that does not waste resources, companies are always in the spotlight for their trends.

An object of the present invention is to solve such a problem, and to provide a dehumidifier and a container thereof, which are capable of reducing the amount of use of plastic or the like and of suppressing transportation and storage costs, considering the environment.

### Solution to Problem

The present invention solves the above-described problems by a dehumidifier that is used in combination with a tablet and a dedicated container, in which the tablet is a hygroscopic desiccant in a state in which a deliquescent substance is pressed and compressed, the dedicated container includes a deliquescent solution storage container, a lid, and a shelf for placing a tablet, the deliquescent solution storage container has an engaging portion for disposing the shelf for placing a tablet at a predetermined height position from an inner bottom surface, and is capable of storing a deliquescent solution of the tablet, the lid ensures firm connection to the deliquescent solution storage container in a state in which the shelf for placing a tablet is interposed, the lid has an opening portion on an upper surface, and the opening portion is sealed with a moisture permeable film, and the shelf for placing a tablet having a hole at least downwardly for allowing the deliquescent solution of the tablet to flow down to the deliquescent solution storage container.

### Advantageous Effects of Invention

According to the present invention having the above-described features, it is possible to provide a dehumidifier in which a container can be reused, and thus it is possible to significantly reduce the amount of use of plastic or the like and to suppress transportation and storage costs.

### BRIEF DESCRIPTION OF DRAWINGS

FIG. 1 is an explanatory view showing an overall configuration of a dehumidifier according to a first embodiment of the present invention, in which (a) of FIG. 1 is a front view of a state in which a lid is attached to a deliquescent solution storage container with a shelf for placing a tablet being interposed, (b) of FIG. 1 is a top view of the state, (c) of FIG. 1 is a top view of a state in which only the lid is removed, (d) of FIG. 1 is a photograph of a tablet for refilling accommodated in an airtight bag, and (e) of FIG. 1 is a photograph of a state in which a tablet is placed on a container from which the lid is removed.

FIG. 2 is an explanatory view showing a deliquescent solution storage container in a dehumidifier according to the first embodiment of the present invention, in which (a) of FIG. 2 is a top view, (b) of FIG. 2 is a front view, (c) of FIG. 2 is a view seen from above in a state in which (a) of FIG. 2 is rotated by 45 degrees, and (d) of FIG. 2 is a view of (c) of FIG. 2 as seen from the front.

FIG. 3 is an explanatory view showing a lid of the dehumidifier according to the first embodiment of the present invention, in which (a) of FIG. 3 is a top view and (b) of FIG. 3 is a cross-sectional view taken along line AA in (a) of FIG. 3.

FIG. 4 is an explanatory view showing a shelf for placing a tablet in the dehumidifier according to the first embodiment of the present invention, in which (a) of FIG. 4 is a top view and (b) of FIG. 4 is a front view.

FIG. 5 is a graph comparing moisture absorption performance of the first embodiment and the granular type desiccant when used in a container sealed with a moisture permeable film.

FIG. 6 is an explanatory view showing a deliquescent solution storage container in the dehumidifier according to the second embodiment of the present invention, in which (a) of FIG. 6 is a top view, (b) of FIG. 6 is a front view, (c) of FIG. 6 is a view seen from above in a state in which (a) of FIG. 6 is rotated by 45 degrees, and (d) of FIG. 6 is a view of (c) of FIG. 6 as seen from the front.

FIG. 7 is an explanatory view showing a shelf for placing a tablet in the dehumidifier according to the second embodiment of the present invention, in which (a) of FIG. 7 is a top view and (b) of FIG. 7 is a front view.

FIG. 8 is a graph comparing the moisture absorption performance of the second embodiment and the granular type desiccant when used in a container sealed with a moisture permeable film.

FIG. 9 is a cross-sectional view illustrating a tank type dehumidifier in the related art.

### DESCRIPTION OF EMBODIMENTS OF INVENTION

Hereinafter, embodiments of the present invention will be described in detail with reference to the accompanying drawings, but the following drawings are created for the purpose of description, and members unnecessary for the description may not be intentionally shown for clarity. In addition, the members may be intentionally shown in an enlarged or reduced scale for description, and the drawings do not show an exact scale.

### First Embodiment

### (Overall Configuration of Dehumidifier)

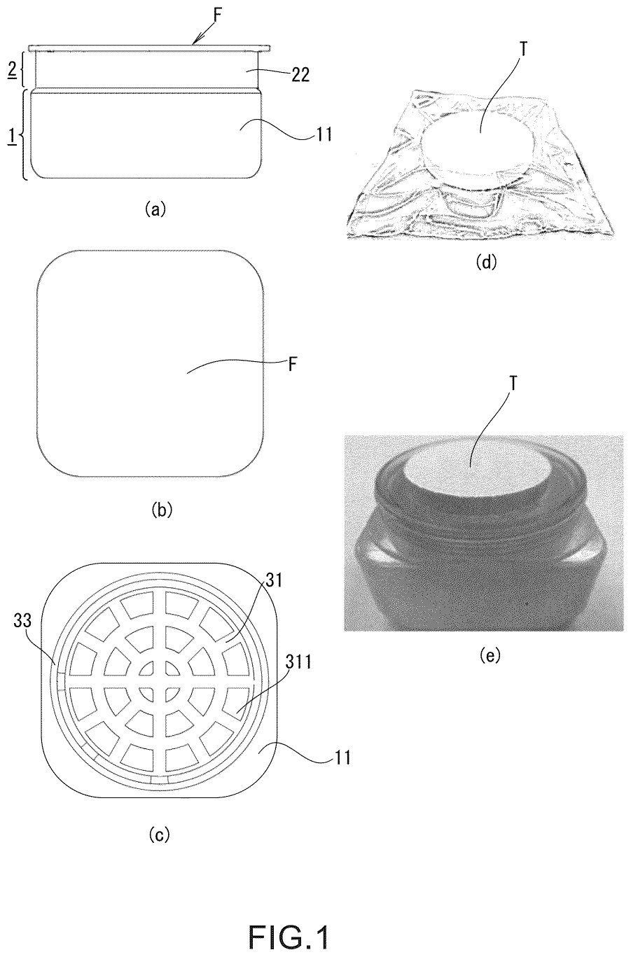

FIG. 1 is an explanatory view showing an overall configuration of dehumidifier according to a first embodiment of the present invention, in which (a) of FIG. 1 is a front view of a state in which a lid is attached to a deliquescent solution storage container with a shelf for placing a tablet being interposed, (b) of FIG. 1 is a top view of the state, (c) of FIG. 1 is a top view of a state in which only the lid is removed, (d) of FIG. 1 is a photograph of a tablet for refilling, and (e) of FIG. 1 is a photograph of a state in which a tablet is placed on a container from which the lid is removed.

The dehumidifier according to the first embodiment of the present invention is a dehumidifier that is used in combination with tablet for refilling and a dedicated container. The tablet T for refilling is a hygroscopic desiccant in a state in which a deliquescent substance is pressed and compressed, and specifically, is a tablet-shaped calcium chloride. The tablet is manufactured by filling the inside of a cylinder of a press (tablet press) of 50t with powdered calcium chloride and extruding the molded product by pressing. The tabletized calcium chloride can achieve a density of 1.63 g/ml only by adjusting the pressure, and practically sufficient strength is secured. It is noted that a tablet of magnesium chloride can also be used as a substitute for calcium chloride. The tablet T for refilling is stored in an airtight transparent bag as shown in (d) of FIG. 1 during storage. This bag is a transparent bag having water vapor barrier properties, for example, made of stretched polypropylene or polyvinylidene chloride, so that the deliquescence of the desiccant does not proceed, but the bag does not have to be transparent. In addition, the film may be subjected to lamination processing such as being bonded to polyethylene or the like using a nylon film, an aluminum foil, or aluminum vapor deposition. As the bonding method, four-side sealing, three-side sealing (folding bonding), standing pouch, blister packaging, and the like can be appropriately adopted. Further, even in a case of a box or a can instead of a bag, the box or the can be adopted as the storage container as long as the box or the can has water vapor barrier properties.

As shown in (a) to (c) in FIG. 1, the dedicated container includes a deliquescent solution storage container 1, a lid 2, and a shelf 3 for placing a tablet. The deliquescent solution storage container 1 is configured to store the deliquescent solution of the tablet T for refilling. The lid 2 ensures a firm connection with the deliquescent solution storage container 1 in a state in which the shelf 3 for placing a tablet is interposed. Specifically, the cap is configured as a screw cap or a twist cap.

From the front view of (a) of FIG. 1, the side surface of the main body lower portion 11 and the lid side surface 22 can be seen. In addition, from the top view of (b) of FIG. 1, it can be seen that the opening portion 212 (not shown) provided on the upper surface of the lid 2 is sealed by welding the moisture permeable film F. On the other hand, from (c) of FIG. 1 showing a state in which the lid 2 is removed, it can be seen that the shelf 3 for placing a tablet is disposed by supporting the flange portion 33 on the edge 13 (not shown) of the opening portion of the deliquescent solution storage container 1. The shelf 3 for placing a tablet is disposed at a predetermined height position from the inner bottom surface of the deliquescent solution storage container 1 by the edge 13 (not shown) supporting the flange portion 33.

As shown in (c) of FIG. 1, the bottom surface hole 311 for allowing the deliquescent solution of the tablet T to flow down to the deliquescent solution storage container 1 is provided in the shelf bottom surface 31 of the shelf 3 for placing a tablet. Since the tablet T for refilling has a specific thickness, the upper surface of the tablet T for refilling is also positioned at a predetermined height from the inner bottom surface of the deliquescent solution storage container 1 as shown in (e) of FIG. 1.

### (Configuration Deliquescent Solution Storage Container)

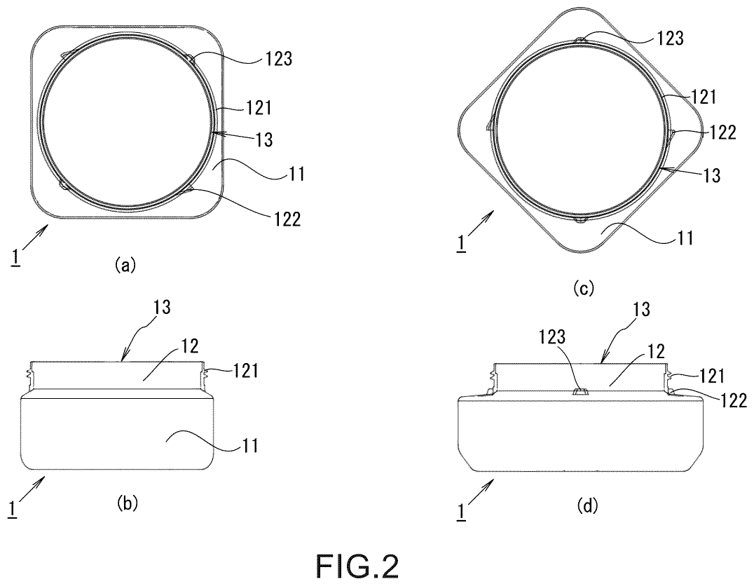

FIG. 2 is an explanatory view showing a deliquescent solution storage container in the dehumidifier according to the first embodiment of the present invention, in which (a) of FIG. 2 is a top view, (b) of FIG. 2 is a front view, (c) of FIG. 2 is a view as seen from above in a state in which (a) of FIG. 2 is rotated by 45 degrees, and (d) of FIG. 2 is a view of (c) of FIG. 2 as seen from the front.

The deliquescent solution storage container 1 is a container having a composite shape, which is composed of a main body lower portion 11 of a rectangular parallelepipedo shape having four chamfered sides and a main body upper portion 12 which is a circular cylindrical portion connected to the main body lower portion 11. When the shelf 3 for placing a tablet (not shown) is disposed, the main body lower portion 11, the area partitioned off by the lower surface of the shelf 3 for placing a tablet (not shown) has a volume sufficient to accommodate the deliquescent solution generated when all of the one tablet T for refilling is deliquesced, and in the first embodiment, the volume is 550 cc. The main body upper portion 12 as a circular cylindrical portion is connected to the upper portion of the main body lower portion 11 so as to be coaxial with the central axis of the main body lower portion 11. Therefore, as shown in (a) of FIG. 2, the upper surface of the main body lower portion 11 is disposed at four corners around the main body upper portion 12.

A male screw portion 121 that is screwed to a female screw portion 221 (not shown) of the lid 2 is formed on an outer periphery of the main body upper portion 12. The screw is preferably a multi-thread screw that can be opened and closed in a small number of rotation turns, and in the first embodiment, the screw is a two-thread screw, but may be a four-thread screw.

The edge 13 of the top portion of the main body upper portion 12 functions to support the flange portion 33 of the shelf 3 (neither shown) for placing a tablet, and thus, the shelf 3 (not shown) for placing a tablet is disposed at a predetermined height position from the inner bottom surface of the deliquescent solution storage container 1.

Two triangular protrusions 122 and two bulging portions 123 are disposed at positions at intervals of 90 degrees near a boundary where the upper surface of the main body lower portion 11 and the main body upper portion 12 are connected to each other. Since the operator feels a click feeling at the end while feeling an increase in torque resistance due to the triangular protrusion 122 and the bulging portion 123 immediately before the end of the lid 2 tightening work, it is possible to confirm that the lid is reliably closed.

### (Configuration of Lid)

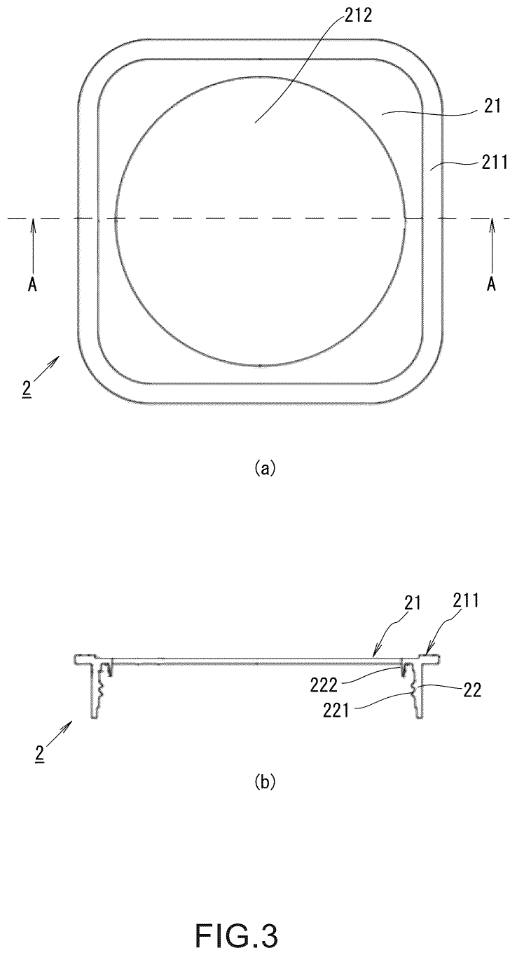

FIG. 3 is an explanatory view showing a lid in the dehumidifier according to the first embodiment of the present invention, in which (a) of FIG. 3 is a top view and (b) of FIG. 3 is a cross-sectional view taken along line AA in (a) of FIG. 3. The lid 2 is roughly formed of the lid upper surface 21 and the lid side surface 22, and a circular opening portion 212 is provided at the center of the lid upper surface 21. On the other hand, as shown in (b) of FIG. 3, the peripheral edge 211 of the lid upper surface 21 is set to be at a position higher than the lid upper surface 21 by one step, and the moisture permeable film F (see FIG. 1) is heat-welded to the peripheral edge 211. In addition, the hanging side 222 is hung down from the outer periphery of the opening portion 212 downward, and the size of the hanging side 222 is set to be in contact with the upper surface of the flange portion 33 of the shelf 3 (neither shown) for placing a tablet when the lid 2 is attached to the deliquescent solution storage container 1 (not shown). That is, a certain interval is present between the lid upper surface 21 and the flange portion 33 (not shown).

The dedicated container in the dehumidifier according to the first embodiment has a configuration in which liquid does not pass through the moisture permeable film F but gas passes through the moisture permeable film F when the lid 2 is closed. Due to the difference in height between the lid upper surface 21 and the peripheral edge 211, the moisture permeable film F is disposed in a state of being slightly spaced from the lid upper surface 21, and thus, in addition to the area of the opening portion 212, an area (that is, an area shown as the lid upper surface 21 in (a) of FIG. 3) between the outer periphery of the opening portion 212 and the inner side of the peripheral edge 211 also contributes to the passage of the gas, which is advantageous in terms of moisture absorption performance. The moisture permeable film is required to have strength that withstands repeated use, and a two-layer structure moisture permeable film in which a nonwoven fabric is laminated on a porous film obtained by stretching polyethylene or polypropylene blended with an inorganic filler can be suitably used. In addition, a three-layer structure moisture permeable film in which a nonwoven fabric, a porous film, and a nonwoven fabric are laminated may be used in order to further increase the strength.

In a general desiccant, since the moisture-proof film is laminated and attached to the moisture permeable film, the moisture-proof film needs to be adhered to the container. In addition, since the moisture-proof film needs to be peeled off in a case of using a desiccant, it is required to be easily peeled off without damaging the porous film layer in that case.

In a case where a moisture-proof film is directly laminated on a porous film obtained by stretching polyethylene or polypropylene blended with an inorganic filler, it is difficult to easily peel off the moisture-proof film without damaging the porous film layer. In order to solve these problems, a nonwoven fabric laminated on a porous film is mainly used. This is because the nonwoven fabric can complement the strength without significantly impairing the moisture permeability of the porous film. In addition, in order to facilitate adhesion to a container and adhesion to a moisture-proof film, the nonwoven fabric is also required to have heat-welding properties.

Therefore, a sheath-core structure of PE and PET is used for the fibers of the nonwoven fabric. In the first embodiment, since the moisture-proof film is not required, the nonwoven fabric (nonwoven fabric on at least one side in a case of a three-layer structure) does not need to be heat-welded, and thus a nonwoven fabric of PP or PET, which is less expensive than the sheath-core structure nonwoven fabric, can be used.

A female screw portion 221 to be screwed to a male screw portion 121 (not shown) formed on the outer periphery of the main body upper portion 12 of the deliquescent solution storage container 1 is formed on the inner periphery of the lid side surface 22. The screw is preferably a multi-thread screw that can be opened and closed in a small number of rotation turns, and in the first embodiment, the screw is a two-thread screw, but may be a four-thread screw. In addition, instead of the female screw portion 221, a cap that is wound and tightened to the male screw portion 121 may be configured as a so-called twist cap by providing a lug (claw) on the inner periphery of the lid side surface 22. As described above, at the end of the lid 2 tightening work, the operator can confirm that the lid 2 is reliably closed since the operator feels the click feeling at the end while feeling that the torque resistance is increased. In addition, since the upper surface shape of the lid 2 has the same shape (chamfered rectangular shape) as the main body lower portion 11 (none of which is shown) of the deliquescent solution storage container 1, the completion of the lid closing can be confirmed from a visual point of view. That is, the operator only needs to confirm whether or not the shapes are aligned.

### (Configuration of Shelf for Placing Tablet)

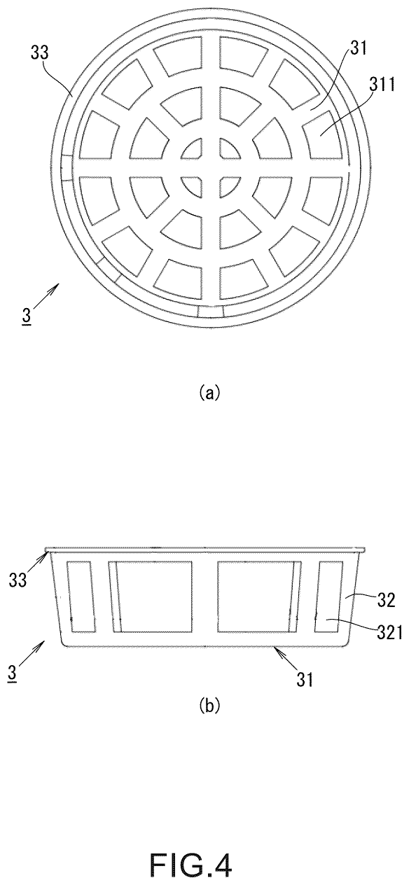

FIG. 4 is an explanatory view showing a shelf for placing a tablet in the dehumidifier according to the first embodiment of the present invention, in which (a) of FIG. 4 is a top view and (b) of FIG. 4 is a front view. The shelf 3 for placing a tablet includes a shelf bottom surface 31, a shelf side surface 32, and a flange portion 33. As a shape of the entire body, as shown in (b) of FIG. 4, a frustum shape in which the shelf bottom surface 31 is smaller than the upper side where the flange portion 33 is provided is adopted.

Bottom surface holes 311 are provided in the shelf bottom surface 31. The bottom surface holes 311 function to allow the deliquescent solution of the tablet T for refilling to flow down into the deliquescent solution storage container 1. The bottom surface holes 311 are disposed at predetermined intervals so that a plurality of arc-shaped holes are positioned along a plurality of concentric circles disposed at different radii. As shown in (a) of FIG. 4, four holes are disposed on the innermost periphery, eight holes are disposed on the next innermost periphery, and twelve holes are disposed on the outermost periphery. The shapes of the holes are not limited to arc shapes, and appropriate shapes can be adopted as long as the desired performance for allowing the deliquescent solution to flow down is exhibited, for example, elongated hole shapes.

Side surface holes 321 are provided in the shelf side surface 32. The side surface holes 321 also contribute to the flow of the deliquescent solution of the tablet T to the deliquescent solution storage container 1. The side surface holes 321 are disposed at predetermined intervals along the outer periphery of the shelf side surface 32 such that eight rectangular (in a front view, and in a strict sense, a shape of an upper side and a lower side of the rectangle that are curved along the shelf side surface) holes are positioned. As the shapes of the holes, appropriate shapes can be adopted as long as the desired performance for allowing the deliquescent solution to flow down is exhibited. In addition, in a case where sufficient performance of the deliquescent solution flowing down is exhibited only by the bottom surface holes 311, the side surface holes 321 can be omitted. Regarding the deliquescent solution flow, the deliquescent solution flow performance varies depending on the use environment due to factors such as the frequency of recrystallization. Therefore, for example, it is considered to vary the specifications depending on the sales area.

The edge 13 (not shown) of the opening portion of the deliquescent solution storage container 1 is dimensionally set to a predetermined height from the inner bottom surface of the deliquescent solution storage container 1. The flange portion 33 of the shelf 3 for placing a tablet is also set to have an appropriate dimension from the bottom surface of the shelf 3 for placing a tablet. Since the tablet T has a unique thickness, the upper surface of the tablet T is positioned at a predetermined height from the inner bottom surface of the deliquescent solution storage container 1. As a result, the interval between the upper surface of the tablet T and the lower surface of the moisture permeable film F facing the upper surface thereof is a close predetermined size at the start of use. The interval is set to be closer than the distance between the moisture permeable film and the granular desiccant in the tank type dehumidifier in the related art by setting the dimension of the hanging side 222 of the lid 2 described above, and contributes to the moisture absorption performance. That will be described later.

(Method of using Dehumidifier)

A method of using the dehumidifier according to the first embodiment of the present invention will be described.
(1) A tablet T for refilling stored in a dedicated container and a transparent bag before use are prepared.
(2) The lid 2 attached to the deliquescent solution storage container 1 is rotated in an opening direction to remove the lid 2. A shelf 3 for placing a tablet is attached in advance to the deliquescent solution storage container 1 from which the lid 2 has been removed. If the shelf 3 has not been attached in advance, the flange portion 33 of the shelf 3 for placing a tablet is placed on the edge 13 of the deliquescent solution storage container 1, and the shelf 3 for placing a tablet is attached to the deliquescent solution storage container 1.
(3) The tablet T for refilling is unsealed.
(4) The extracted tablet T for refilling is placed inside the shelf 3 for placing a tablet.
(5) When the lid 2 is rotated in a closing direction with respect to the deliquescent solution storage container 1, and finally, it is confirmed that the torque resistance is increased, a click feeling is obtained, and the shape of the lid 2 overlaps the shape of the main body lower portion 11 of the deliquescent solution storage container 1, the cap is completely tightened.
(6) The dehumidifier is set in a space such as a closet, a chest of drawers, or a shoe box in which dehumidification is desired, and the space is dehumidified.
(7) When the tablet T is all deliquesced and the dehumidification performance is deteriorated, the lid 2 and the shelf 3 for placing a tablet are removed, and the deliquescent solution accumulated in the deliquescent solution storage container 1 is allowed to flow out and discarded. n addition, the inside of the deliquescent solution storage container 1 and the shelf 3 for placing a tablet are washed as necessary.
(8) The process returns to (2), and the reuse can be performed by using a new tablet T for refilling.

### (Moisture Absorption Performance of Dehumidifier)

According to the research by the present inventors, it seems that a desiccant as a tablet has been used in overseas countries. However, there is no device such as a container for that purpose, and the situation is that the tablet is placed on a grating in an appropriate container and used. As described above, in order to increase the moisture absorption performance of the dehumidifier, it is necessary to secure a large contact area of the desiccant with the hygroscopic desiccant and the air, and thus a granular desiccant tends to be preferred. In fact, in a case where the same volume of a granular desiccant and a tablet-shaped desiccant were prepared and an experiment was carried out to confirm the difference in moisture absorption performance, a significant difference was observed in the moisture absorption performance. Although it is needless to say that the tablet is easier to handle, in overseas countries, granular desiccants are overwhelmingly used. It is presumed that the moisture absorption performance is taken into much consideration.

In overseas, it is described that the tablet is placed on a grating in an appropriate container and used, but the appropriate container is not provided with a moisture permeable and non-water permeable moisture permeable film. One of the purposes of using the moisture permeable film is to prevent the deliquescent solution from being spilled into the drawer or the like in a case where the dehumidifier is accidentally turned over. As described above, the moisture permeable film has a configuration unique to Japanese products that are easy to use, but such consideration is not taken into account in foreign countries.

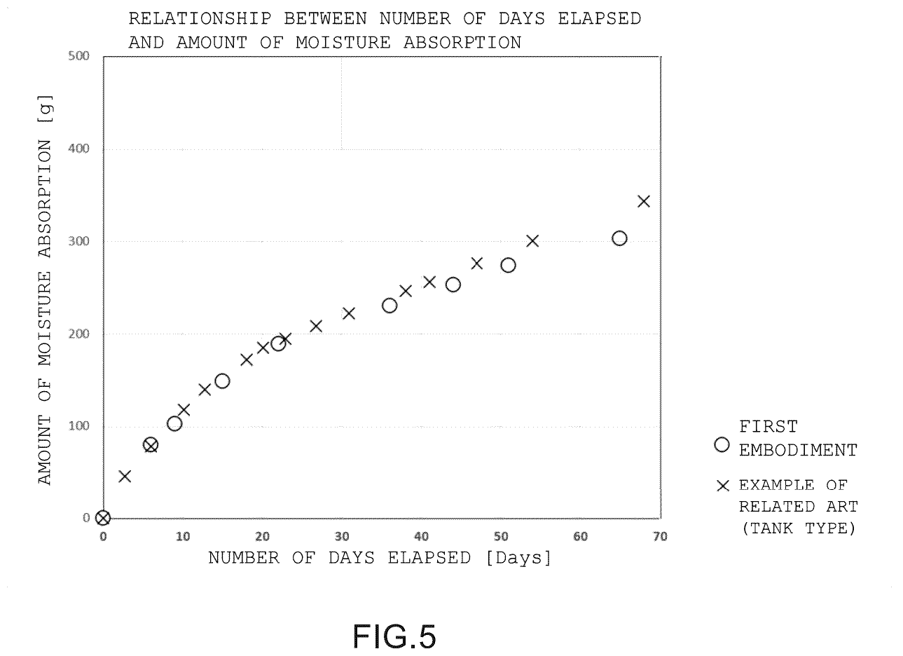

The present inventors also performed an experiment on the moisture absorption performance of the dehumidifier according to the first embodiment of the present invention, that is, the dehumidifier in an aspect in which the tablet T for refilling is placed on the dedicated container. That is, as shown in FIG. 5, a comparative test was performed on a relationship between the number of days elapsed and the amount of moisture absorption in a case where the tank type dehumidifier of the first embodiment and the related art in the use start state were placed in an atmosphere of a temperature of 25±2 °C and a humidity of (80±5)%. An object of the present invention is to significantly reduce the amount of use of plastic or the like and to suppress transportation and storage costs. The present inventor thought that it was inevitable that the moisture absorption performance was sacrificed to some extent, but the results were surprising. As shown in FIG. 5, in the first embodiment, it was possible to confirm the moisture absorption performance that was not inferior to that of the tank type dehumidifier of the related art at all. The reason for that is considered as follows. In a case where the dissolution rates of deliquescent substances having the same weight and the same concentration are compared between “a plurality of granules” and “one tablet” without using a moisture permeable film, the granules having a large surface area are more advantageous. However, in the case of the dehumidifier including the moisture permeable film, it is presumed that the “flow rate of water vapor drawn into the container through the moisture permeable film” is determined by the “performance of the moisture permeable film”, the “area of the opening portion of the lid and the upper portion of the container”, the “surface area of the deliquescent substance”, and the “distance between the deliquescent substance and the moisture permeable film” from the structure of the dehumidifier. The first embodiment is advantageous in that these parameters can be easily adjusted, and particularly, the distance between the deliquescent substance and the moisture permeable film can be set to be close to each other with high accuracy.

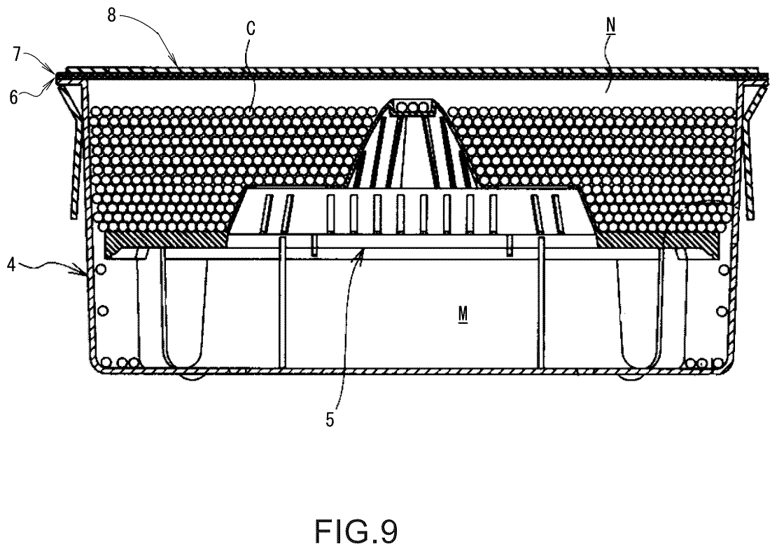

As shown in FIG. 9 illustrating a tank type dehumidifier in the related art, in an upper space in which the granular desiccant is stored, a space with a certain degree of margin is formed between the granular desiccant and the moisture permeable film. This is because there is a request that it is preferable not to excessively fill the granular desiccant in order to secure a large contact area. Originally, the present invention is set such that the distance between the moisture permeable film and the tablet for refilling is close to each other in order to achieve compactness from the viewpoint of cost reduction, but as a result, an unexpected effect is exhibited.

### Second Embodiment

The dehumidifier according to the second embodiment of the present invention is common to the first embodiment in that the dehumidifier is a dehumidifier used by combining the tablet for refilling with the dedicated container, and the dedicated container is reused by using the tablet T for refilling stored in the transparent bag having water vapor barrier properties. However, the second embodiment is different from the first embodiment in that two tablets T for refilling are used and the deliquescent solution storage container 1A and the shelf 3A for placing tablets are large in size. However, the same lid 2 as that of the first embodiment is used.

### (Configuration of Deliquescent Solution Storage Container)

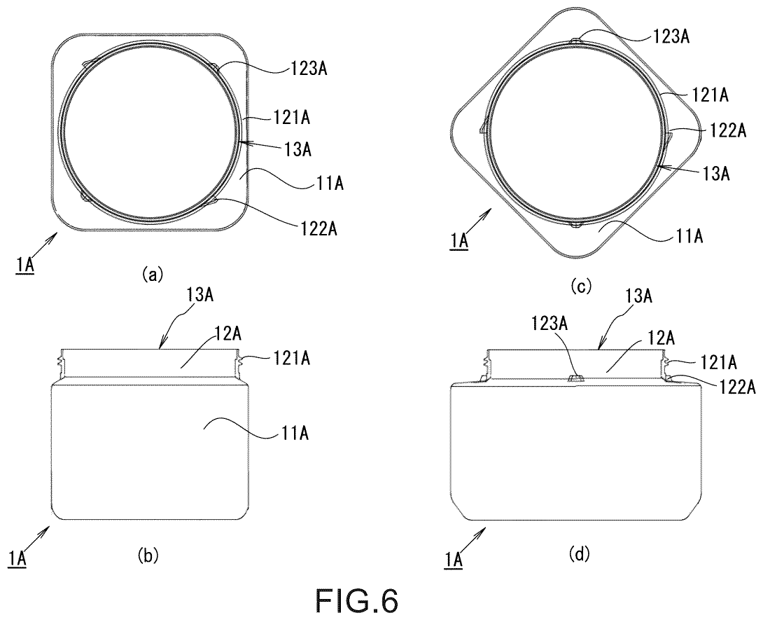

FIG. 6 is an explanatory view showing a deliquescent solution storage container in the dehumidifier according to the second embodiment of the present invention, in which (a) of FIG. 6 is a top view, (b) of FIG. 6 is a front view, (c) of FIG. 6 is a view seen from above in a state in which (a) of FIG. 6 is rotated by 45 degrees, and (d) of FIG. 6 is a view of (c) of FIG. 6 seen from the front.

The deliquescent solution storage container 1A is a container having a composite shape, which is composed of a main body lower portion 11A of a rectangular parallelepipedo shape having chamfered four sides, and a main body upper portion 12A which is a circular cylindrical portion connected to the main body lower portion 11A. When the shelf 3A for placing tablets (not shown) is disposed, the main body lower portion 11A, the area partitioned off by the lower surface of the shelf 3A for placing tablets (not shown) has a volume sufficient to accommodate the deliquescent solution generated when all of the two tablets T are deliquesced, and in the second embodiment, the volume is 1000 cc. The main body upper portion 12A as a circular cylindrical portion is connected to the upper portion of the main body lower portion 11A so as to be coaxial with the central axis of the main body lower portion 11A, and thus, as shown in (a) of FIG. 6, the upper surface of the main body lower portion 11A is disposed at four corners around the main body upper portion 12A.

A male screw portion 121A that is screwed to a female screw portion 221 (not shown) of the lid 2 is formed on an outer periphery of the main body upper portion 12A. The screw is preferably a multi-thread screw that can be opened and closed in a small number of rotation turns. In the second embodiment, the screw is a two-thread screw, but may be a four-thread screw.

The edge 13A of the top portion of the main body upper portion 12A functions to support the flange portion 33A of the shelf 3A (neither shown) for placing tablets, and thus, the shelf 3A (not shown) for placing tablets is disposed at a predetermined height position from the inner bottom surface of the deliquescent solution storage container 1A.

Two triangular protrusions 122A and two bulging portions 123A are disposed at positions at every 90 degrees near a boundary where the upper surface of the main body lower portion 11A and the main body upper portion 12A are connected to each other. Since the operator feels a click feeling at the end while feeling an increase in torque resistance due to the triangular protrusion 122A and the bulging portion 123A immediately before the end of the lid 2 tightening work, it is possible to confirm that the lid is reliably closed.

(Configuration of Shelf for placing Tablets)

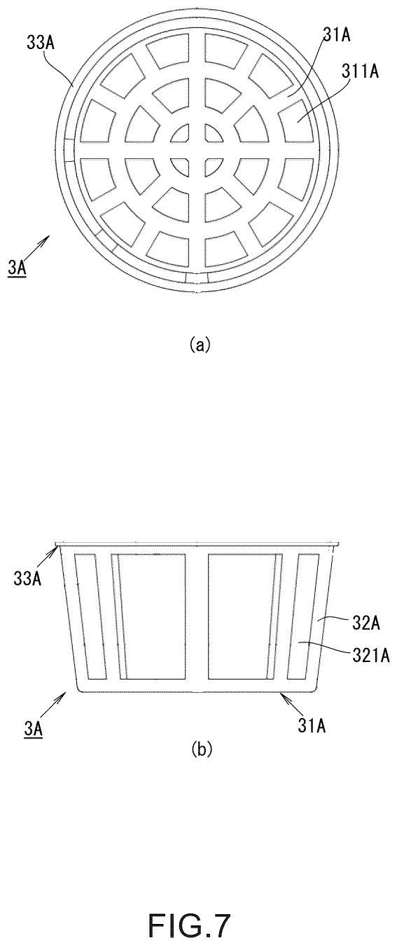

FIG. 7 is an explanatory view showing a shelf for placing tablets in the dehumidifier according to the second embodiment of the present invention, in which (a) of FIG. 7 is a top view and (b) of FIG. 7 is a front view. The shelf 3A for placing tablets includes a shelf bottom surface 31A, a shelf side surface 32A, and a flange portion 33A. As shown in (b) of FIG. 7, the entire shape is a frustum shape in which the shelf bottom surface 31A is smaller than the upper side on which the flange portion 33A is provided.

Bottom surface holes 311A are provided in the shelf bottom surface 31A. The bottom surface holes 311A function to allow the deliquescent solution of the tablets T to flow down to the deliquescent solution storage container 1A. The bottom surface holes 311A are disposed at predetermined intervals so that a plurality of arc-shaped holes are positioned along a plurality of concentric circles disposed at different radii. As shown in (a) of FIG. 7, four holes are disposed on the innermost periphery, eight holes are disposed on the next periphery, and twelve holes are disposed on the outermost periphery. The shapes of the holes are not limited to arc shapes, and appropriate shapes can be adopted as long as the desired performance for allowing the deliquescent solution to flow down is exhibited, for example, elongated hole shapes.

Side surface holes 321A are provided in the shelf side surface 32A. The side surface holes 321A also contribute to the flowing down of the deliquescent solution of. the tablet T into the deliquescent solution storage container 1. The side surface holes 321 are disposed at predetermined intervals along the outer periphery of the shelf side surface 32 such that eight rectangular (in a front view, and in a strict sense, shapes of an upper side and a lower side of the rectangle that are curved along the shelf side surface) holes are positioned. As the shapes of the holes, appropriate shapes can be adopted as long as the desired performance for allowing the deliquescent solution to flow down is exhibited. In addition, in a case where sufficient performance of the deliquescent solution flowing down is exhibited only by the bottom surface holes 311A, the side surface holes 321A can be omitted.

The edge 13A (not shown) of the opening portion of the deliquescent solution storage container 1A is dimensionally set to a predetermined height from the inner bottom surface of the deliquescent solution storage container 1A. The flange portion 33A of the shelf 3A for placing a tablet is also set to have an appropriate dimension from the bottom surface of the shelf 3A for placing tablets. In addition, since the tablets T for refilling each has a unique thickness and the height (thickness) of two tablets T for refilling is also a predetermined unique value, the upper surface of the tablet T for refilling is positioned at a predetermined height from the inner bottom surface of the deliquescent solution storage container 1A. As a result, the interval between the upper surface of the tablet T for refilling and the lower surface of the moisture permeable film F facing the upper surface is a predetermined size. The interval is not changed from the first embodiment, and thus, the moisture absorption performance is good as described above. However, in a case where the deliquescence of the two tablets T for refilling proceeds, the interval is larger than the interval in a case where the deliquescence proceeds in the first embodiment, and thus it cannot be denied that there is a slight disadvantage in terms of deterioration in moisture absorption performance with time. However, the second embodiment is more advantageous than the first embodiment in that the use period can be lengthened.

(Method of using Dehumidifier)

The method of using the dehumidifier according to the second embodiment of the present invention is not significantly different from that of the first embodiment. The only difference is that two tablets T for refilling are stored in a transparent bag is prepared. Of course, in a case where two tablets T for refilling in a bag cannot be prepared, two bags of the tablet T for recharging in which one tablet each is stored may be prepared. The dehumidifier is reused in units of two tablets by placing two tablets of the tablet T for refilling and discarding the deliquescent solution of two tablets.

### (Moisture Absorption Performance of Dehumidifier)

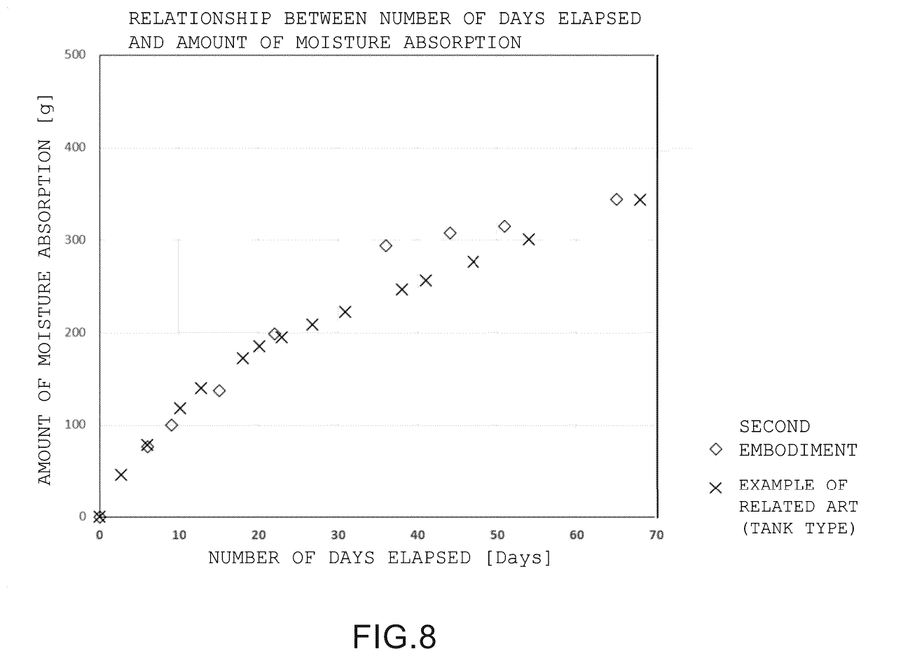

As shown in FIG. 8, a comparative test was performed on a relationship between the number of days elapsed and the amount of moisture absorption in a case where the tank type dehumidifier of the second embodiment in the use start state and the related art were placed in an atmosphere of a temperature of 25±2 °C and a humidity of (80±5) %. As shown in FIG. 8, the second embodiment shows results that are slightly higher than the moisture absorption performance of the tank type dehumidifier of the related art.

Hereinabove, the dehumidifier according to the embodiment of the present invention has been described in detail with reference to the drawings, and the structure thereof has been described. However, the specific configuration is not limited to these embodiments, and the present invention includes a design change or the like without departing from the scope of the present invention. For example, the rectangular shape which is a common shape of the deliquescent solution storage container and the lid may be a circular shape. Although the function of visually confirming the completion of the lid closure is lost, the operator can perceive the completion of the operation with only the increase in torque resistance due to the triangular protrusion or the bulging portion and the tactile sensation of the hand due to the click feeling. Further, regardless of whether the shape is a rectangular shape or a circular shape, in a case where the twist cap aspect is adopted, it is also possible to omit the triangular protrusion or the bulging portion. In the first place, the twist cap is completed to be tightened by the resistance felt by the lugs (claws) present on the inner periphery of the lid portion.

In the embodiments, the engaging portion for disposing the shelf for placing a tablet is the edge of the upper surface of the deliquescent solution storage container, and the shelf for placing a tablet is the flange portion. However, for example, a configuration in which a recess portion provided on the inner surface of the container and a protrusion portion provided on the shelf for placing a tablet (or tablets) are engaged with each other, or the like may be used as the engaging portions as long as the shelf for placing a tablet (or tablets) can be properly set at a predetermined height position.

In the embodiments, the shape of the shelf for placing a tablet (or tablets) was a frustum shape, but may be a cylindrical shape. Similarly, the shape of the tablet(s) T for refilling is (are) preferably a frustum shape or a cylindrical shape in terms of efficiently accommodating the tablet(s) T for refilling on the middle shelf, but the tablet(s) T for refilling may be a sphere, and the shape of the tablet(s) T for refilling is (are) not particularly limited as long as the tablet(s) T for refilling is (are) accommodated on the middle shelf. From the reason described in the section of the moisture absorption performance of the dehumidifier, the moisture absorption performance may be slightly sacrificed, but the object of the present invention is to reuse resources and suppress transportation costs and storage costs, and thus the decrease in moisture absorption performance would not deviate from the technical idea of the present invention.

As described above, the size and shape of the bottom surface holes or the side surface holes may be appropriately adopted as long as the intended function is performed, but a different type may be prepared as summer/winter or spring/autumn type, and may be used by being replaced according to the season. In a season in which the temperature difference (difference between cold and hot) is large, since the clogging of pores due to recrystallization is likely to occur, it is advantageous to use pore shapes having large sizes. As a contrary idea, in a case where the container is used in a season in which recrystallization is unlikely to occur, the container may be a container for a tablet type and a granular type, in which the bottom surface holes are small enough to not allow granular desiccant to pass through, and the container is a target for a refill desiccant. The container can be reused without being discarded, and thus the cost can be reduced as compared with the dehumidifier in the related art that is forced to discard the container by peeling off the moisture permeable film. As described above, even in a case where a granular desiccant is used, it does not deviate from the technical idea of the present invention from the viewpoint of the invention of the container for a dehumidifier.

### REFERENCE SYMBOLS LIST

1: deliquescent solution storage container
11: main body lower portion
12: main body upper portion
121: male screw portion
122: triangular protrusion
123: bulging portion
2: lid
21: lid upper surface
211: peripheral edge
212: opening portion
22: lid side surface
221: female screw portion
222: hanging side
3: shelf for placing tablets
31: shelf bottom surface
311: bottom surface hole
32: shelf side surface
321: side surface hole
33: flange portion
1A deliquescent solution storage container
11A: main body lower portion
12A: main body upper portion
121A: male screw portion
122A: triangular protrusion
123A: bulging portion
3A: shelf for placing tablet
31A: shelf bottom surface
311A: bottom surface hole
32A: shelf side surface
321A: side surface hole
33A: flange portion
T: tablet (tablet for refilling)

1. A dehumidifier that is used in combination with at least one tablet and a dedicated container, wherein
the at least one tablet is a hygroscopic desiccant in a state in which a deliquescent substance is pressed and compressed,
the dedicated container includes a deliquescent solution storage container, a lid, and a shelf for placing at least one tablet,
the deliquescent solution storage container has an engaging portion for disposing the shelf for placing at least one tablet at a predetermined height position from an inner bottom surface, and is capable of storing a deliquescent solution of the at least one tablet,
the lid ensures firm connection to the deliquescent solution storage container in a state in which the shelf for placing at least one tablet is interposed, the lid has an opening portion on an upper surface, and the opening portion is sealed with a moisture permeable film, and
the shelf for placing at least one tablet has a hole at least downwardly for allowing the deliquescent solution of the at least one tablet to flow down to the deliquescent solution storage container.

2. The dehumidifier according to claim 1, wherein
the shelf for placing at least one tablet has a concave overall shape, and
a shelf portion of a bottom surface is set such that a distance between a lower surface of the moisture permeable film and an upper surface of the tablet is close to each other when a predetermined number of the tablets are placed while having a sufficient depth for storing the tablets.

3. The dehumidifier according to claim 1,
wherein the engaging portion is an edge of an upper surface of the deliquescent solution storage container, and
the engaged portion of the shelf for placing at least one tablet is a flange provided on the shelf for placing at least one tablet.

4. A container for a dehumidifier that can be used as a dehumidifier by storing at least one tablet as a hygroscopic desiccant in a state in which a deliquescent substance is pressed and compressed, the container comprising:
a deliquescent solution storage container;
a lid; and
a shelf for placing at least one tablet, wherein
the deliquescent solution storage container has an engaging portion for disposing the shelf for placing at least one tablet at a predetermined height position from an inner bottom surface, and is capable of storing a deliquescent solution of the tablet,
the lid ensures firm connection to the deliquescent solution storage container in a state in which the shelf for placing at least one tablet is interposed, the lid has an opening portion on an upper surface, and the opening portion is sealed with a moisture permeable film, and
the shelf for placing at least one tablet has a hole at least downwardly for allowing the deliquescent solution of the tablet to flow down to the deliquescent solution storage container.

5. The dehumidifier according to claim 2,
wherein the engaging portion is an edge of an upper surface of the deliquescent solution storage container, and
the engaged portion of the shelf for placing at least one tablet is a flange provided on the shelf for placing at least one tablet.
